(19) United States
(12) Patent Application Publication
(10) Pub. No.: US 2011/0029868 A1
(43) Pub. Date: Feb. 3, 2011

(54) USER INTERFACES FOR SMALL ELECTRONIC DEVICES

(75) Inventors: Dov Moran, Kfar Saba (IL); Michal Levin, Tel Aviv (IL); Orlee Tal, Tel Aviv (IL); Uriel Brison, Tel Aviv (IL)

Correspondence Address: Soquel Group, LLC, P.O. Box 691, Soquel, CA, 95073, US

(73) Assignee: MODU LTD., Kfar Saba (IL)

(21) Appl. No.: 12/848,178

(22) Filed: Aug. 1, 2010

Related U.S. Application Data
(60) Provisional application No. 61/230,719, filed on Aug. 2, 2009.

(51) Int. Cl. G06F 3/048; G06F 3/01

(52) U.S. Cl. 715/702; 715/833; 715/830

(57) ABSTRACT

A user interface for a mobile electronic device, including a slider bar that supports three user inputs; namely, (i) slide up, (ii) slide down, and (iii) press, wherein slide up and slide down cause respective scrolling up and scrolling down through a menu of items, and wherein press causes selection of a scrolled-to menu item.

### CROSS REFERENCES TO RELATED APPLICATIONS

This application claims benefit of U.S. Provisional Application No. 61/230,719, entitled USER INTERFACES FOR SMALL ELECTRONIC DEVICES, filed on Aug. 2, 2009 by inventors Dov Moran, Michal Levin, Orlee Tal and Uriel Brison.

### FIELD OF THE INVENTION

The field of the present invention is user interfaces for cellular phones and other small electronic devices.

### BACKGROUND OF THE INVENTION

When it comes to small hand-held electronic devices, much creativity is required in designing efficient compactly arranged user interface controls such as keypads, buttons, soft keys, dials, switches and touch screens, and mapping out their functions. Conventional controls, such as QWERTY keyboards and 12-key numpads are too large to be comfortably accommodated on today's miniature devices.

There is thus a need for innovative design of user interface controls and features for small devices, especially for devices that support many functions, such as cell phones, schedulers, personal data assistants, radios, televisions and media players. Innovative designs carefully take into consideration engineering factors, human factors and cost factors.

### SUMMARY OF THE DESCRIPTION

Aspects of the present invention relate to user interfaces for mobile electronic devices. The user interfaces may be physical controls. Alternatively, the user interfaces may be touch-based controls, operated by finger movements on a touch-sensitive screen. Embodiments of the present invention include a slider bar, a crossbar and an active ribbon.

Further aspects of the present invention relate to special user interface features for general user interfaces. Such features include inter alia features for retrieving a history of actions, reviewing previous activity, using a wizard, displaying most probable items, displaying most recent items, finding out status of social contacts, and performing a search.

There is thus provided in accordance with an embodiment of the present invention a user interface for a mobile electronic device, including a slider bar that supports three user inputs; namely, (i) slide up, (ii) slide down, and (iii) press, wherein slide up and slide down cause respective scrolling up and scrolling down through a menu of items, and wherein press causes selection of a scrolled-to menu item.

### BRIEF DESCRIPTION OF THE DRAWINGS

The present invention will be more fully understood and appreciated from the following detailed description, taken in conjunction with the drawings in which:

FIG. 1 is a simplified illustration of a standalone modular communicator, and a jacket for the modular communicator, in accordance with an embodiment of the present invention;

FIG. 2 is a simplified illustration of a user interface for a standalone modular communicator displayed within a jacket for the modular communicator, in accordance with an embodiment of the present invention;

FIG. 3 is a simplified illustration of industrial designs for a slider key user interface control for a modular communicator, in accordance with an embodiment of the present invention;

FIG. 4 is an illustration of a user interface operative for making an outgoing call using a slider bar, in accordance with an embodiment of the present invention;

FIG. 5 is an illustration of a user interface operative for sending a text message using a slider bar, in accordance with an embodiment of the present invention;

FIG. 6 is an illustration of a user interface for entering text using a slider bar, in accordance with an embodiment of the present invention;

FIG. 7 is an illustration of a user interface operative for editing an entry in a contact list using a slider bar, in accordance with an embodiment of the present invention;

FIG. 8 is an illustration of a user interface operative for accessing an application using a crossbar, in accordance with an embodiment of the present invention;

FIG. 9 is an illustration of a user interface operative for editing an entry in a contact list using a crossbar, in accordance with an embodiment of the present invention;

FIG. 10 is an illustration of a user interface operative for making an outgoing phone call using a crossbar, in accordance with an embodiment of the present invention;

FIG. 11 is an illustration of a user interface operative for receiving an incoming phone call using a crossbar, in accordance with an embodiment of the present invention;

FIG. 12 is an illustration of a first user interface operative for sending a multi-media message using an active ribbon, in accordance with an embodiment of the present invention;

FIG. 13 is an illustration of a second user interface operative for sending a multi-media message using an active ribbon, in accordance with an embodiment of the present invention;

FIG. 14 is an illustration of a user interface operative for retrieving a history using an active ribbon, in accordance with an embodiment of the present invention;

FIG. 15 is an illustration of a user interface operative for reviewing previous activity, in accordance with an embodiment of the present invention;

FIG. 16 is an illustration of a user interface operative for providing a wizard, in accordance with an embodiment of the present invention;

FIG. 17 is an illustration of a user interface operative for displaying most probable items, in accordance with an embodiment of the present invention;

FIG. 18 is an illustration of a user interface operative for finding out status of social contacts, in accordance with an embodiment of the present invention; and

FIG. 19 is an illustration of a user interface operative for performing a search, in accordance with an embodiment of the present invention.

### DETAILED DESCRIPTION

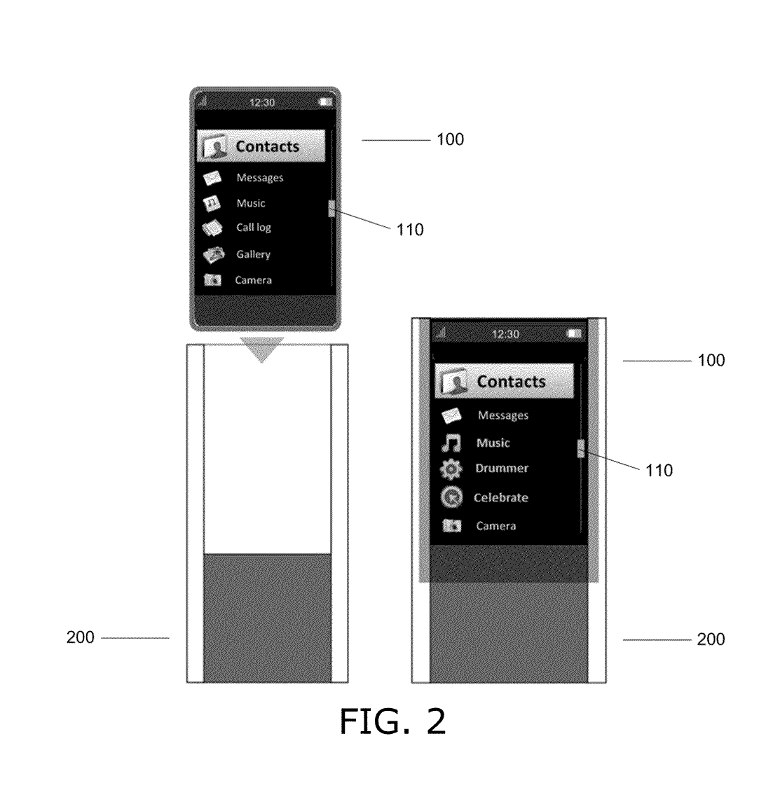

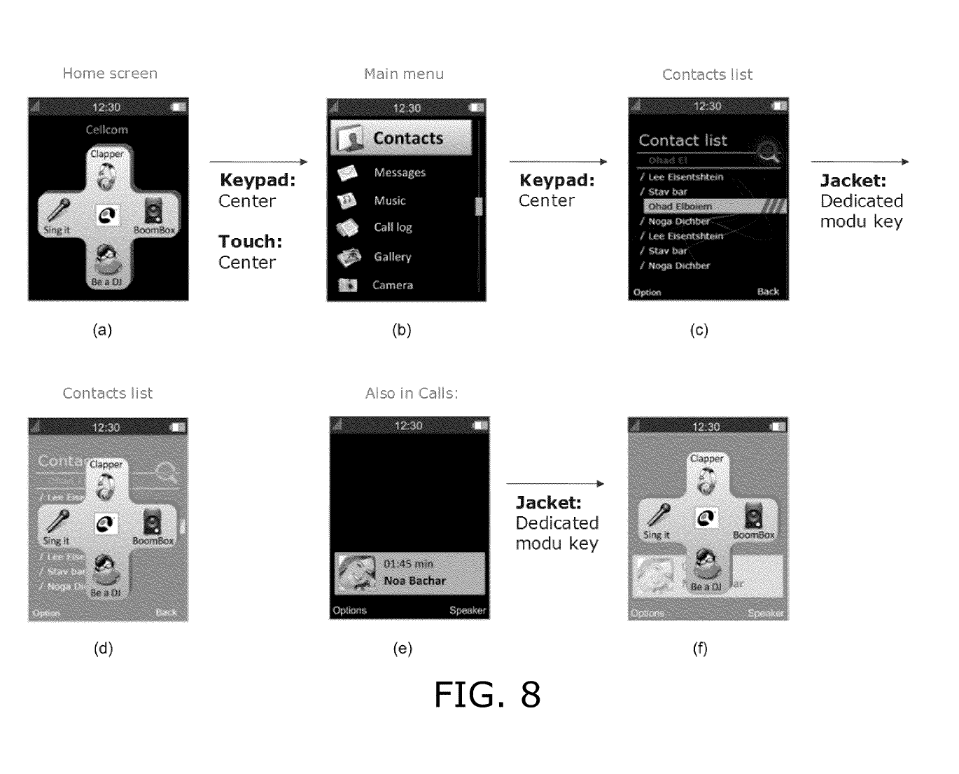

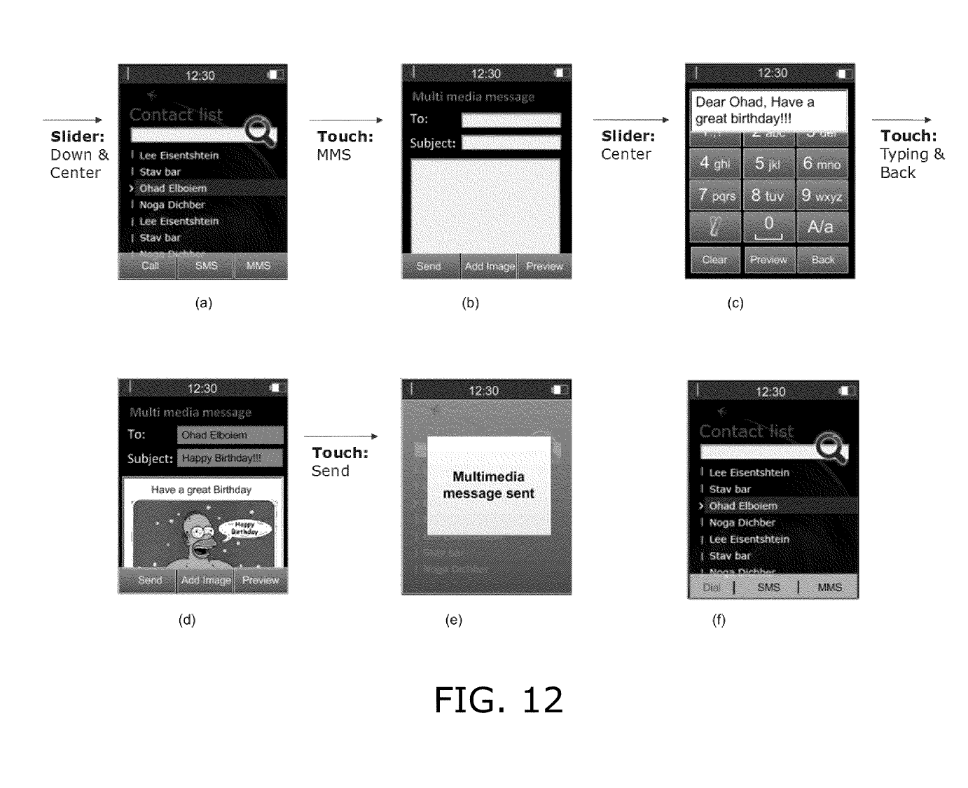

Aspects of the present invention relate to user interfaces for mobile electronic devices. Embodiments of the present invention include a slider bar control (FIGS. 2-7), a crossbar control (FIGS. 8-11) and an active ribbon control (FIGS. 12-14).

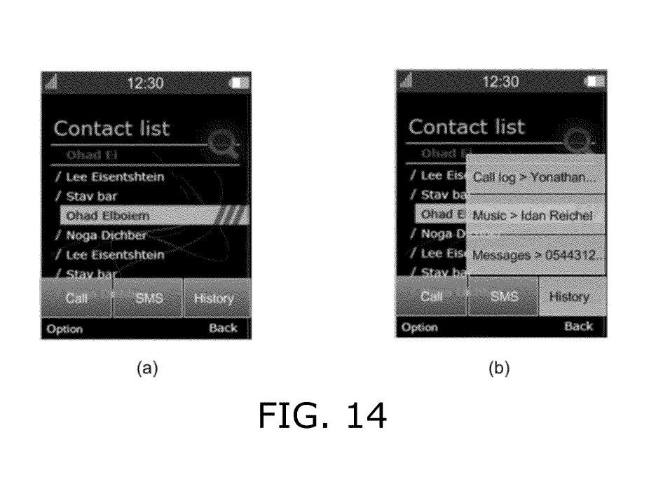

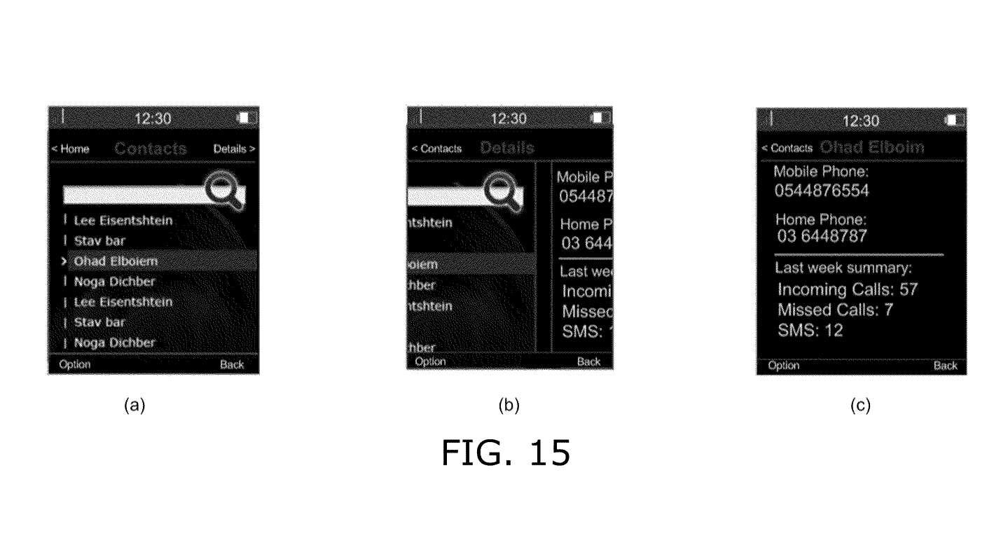

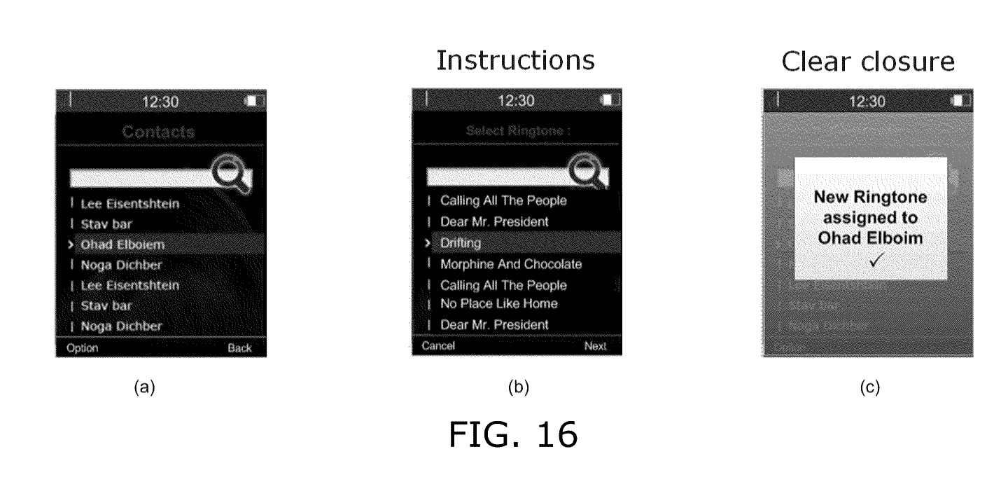

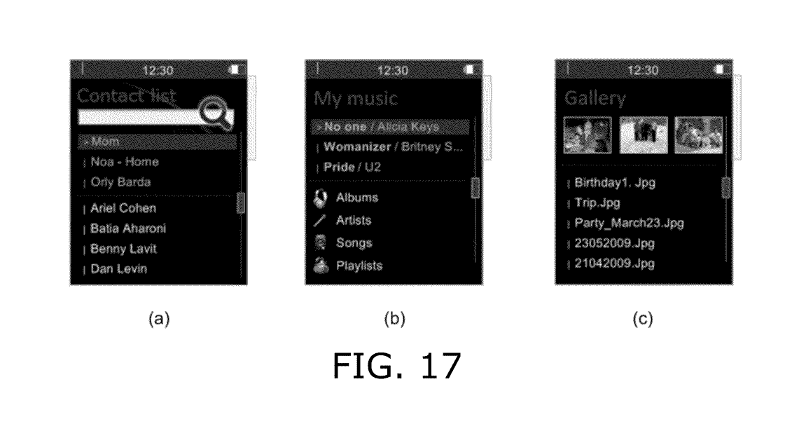

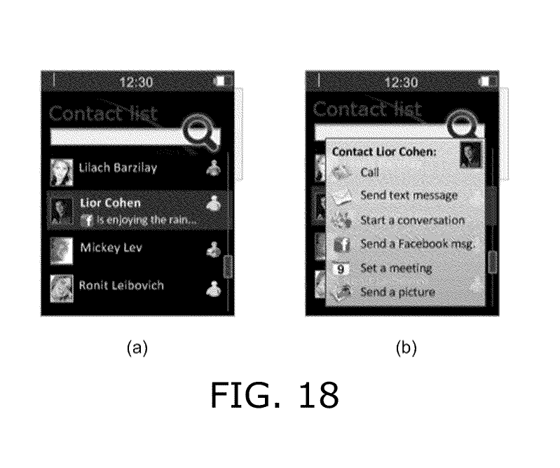

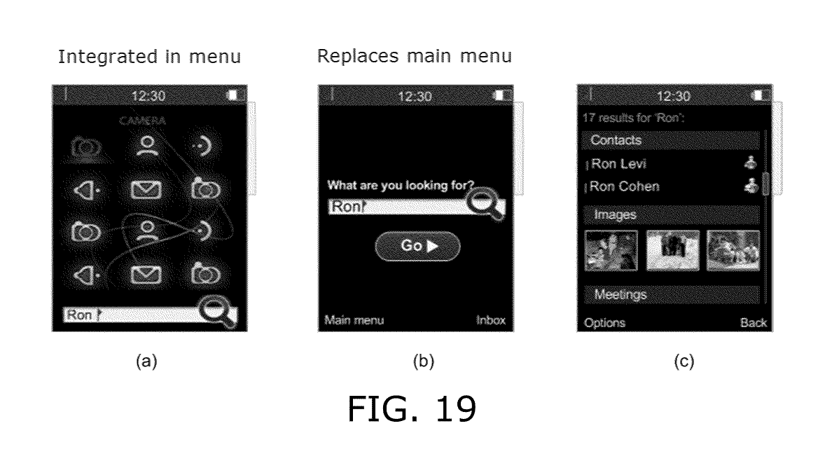

Further aspects of the present invention relate to special features of general user interfaces. Embodiments of the present invention include features for retrieving a history of actions (FIG. 14), reviewing previous activity (FIG. 15), using a wizard (FIG. 16), displaying most probable items (FIG. 17), displaying most recent items (FIG. 17), finding out status of social contacts (FIG. 18), and performing a search (FIG. 19).

The user interfaces of the present invention apply to a wide variety of mobile electronic devices—phones, pagers, radios, televisions, media players, cameras, portable data assistants (PDAs), geographical positioning system (GPS) navigators, e-book readers, game players, schedulers, and much much more. For the sake of clarity, the descriptions hereinbelow relates to a modular communicator and to jackets therefor, such as the Modu™ communicator and jackets developed and manufactured by Modu Ltd. of Kfar Saba, Israel. Those skilled in the art will readily appreciate that the user interfaces described hereinbelow apply to other electronic devices as well as to communicators and jackets.

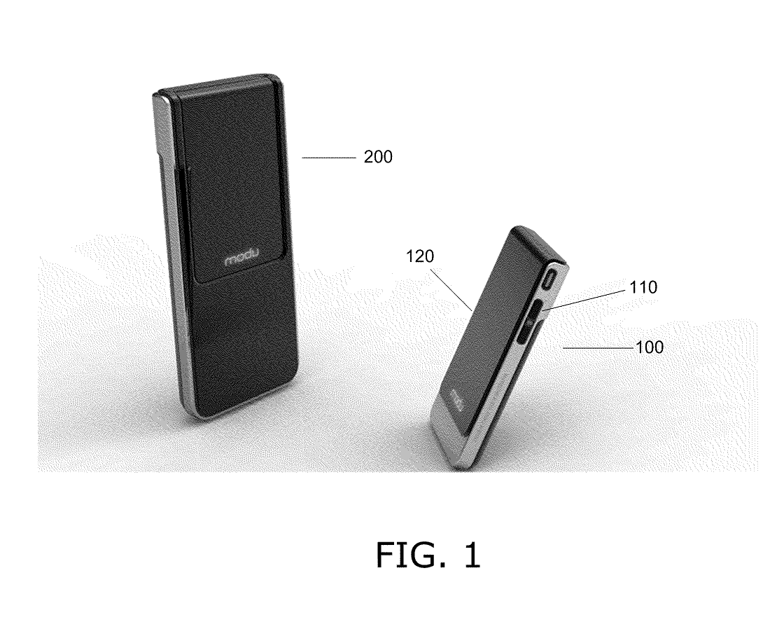

Reference is made to FIG. 1, which is a simplified illustration of a standalone modular communicator 100, and a jacket 200 for modular communicator 200, in accordance with an embodiment of the present invention. Modular communicator 100 may be very small, and in one embodiment of the present invention it has a 2.2″ screen 110 with a 3×6 array of touch-sensitive sub-areas. Jacket 200 shown in FIG. 1 has a transparent cover that exposes screen 110. In one embodiment of the present invention, jacket 200 has a full keypad that includes dedicated keys.

Reference is made to FIG. 2, which is a simplified illustration of a user interface main menu for modular communicator 100 displayed within jacket 200 for the modular communicator, in accordance with an embodiment of the present invention. As shown in FIG. 2, screen 110 of modular communicator 100 is exposed through jacket 200. Use of the user interface displayed on screen 110 is described in detail hereinbelow.

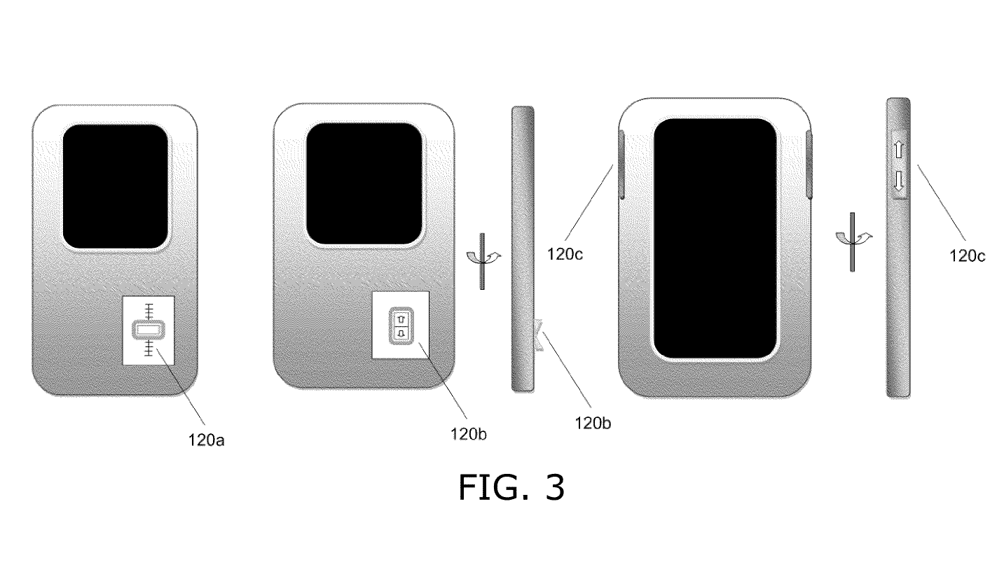

Modular communicator 100 shown in FIG. 1 includes a slider key 120. Reference is made to FIG. 3, which is a simplified illustration of various industrial designs 120a, 120b and 120c for slider key 120, in accordance with an embodiment of the present invention. In some embodiments of the present invention, slider key 120 may be pushed, and may also be slid up or down by a user. For example, pushing slider key 120 causes display of a menu, sliding slider key 120 up or down causes scrolling up or down through the menu, and then pushing slider key 120 causes selection of the item scrolled to in the menu. In some embodiments of the present invention, slider key 120 has multiple levels of up and down, corresponding to different rates of scrolling. Generally, however, slider key 120 can be pushed for selecting a menu item only when it is in the middle; i.e., not up and not down.

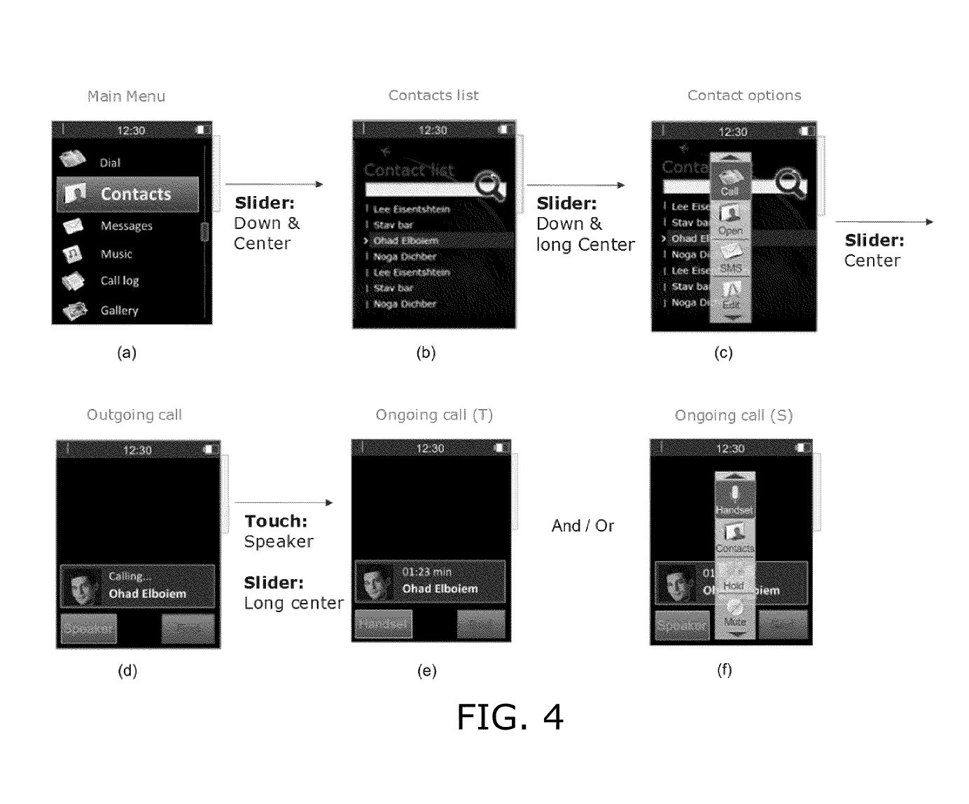

The ensuing discussion describes three user interfaces for modular communicator 100, in conjunction with FIGS. 4-19; namely, (i) a slider bar, (ii) a crossbar and (iii) an active ribbon. For ease of reference, the following table summarizes the operations illustrated in these figures.

TABLE I
Summary of User Interface Figures

| Figure | User Interface | Operation |
|---|---|---|
| 4 | Slider Bar | Making an outgoing phone call |
| 5 | Slider Bar | Sending a text message |
| 6 | Slider Bar | Entering text |
| 7 | Slider Bar | Editing an entry in a contact list |
| 8 | Crossbar | Accessing an application |
| 9 | Crossbar | Editing an entry in a contact list |
| 10 | Crossbar | Making an outgoing phone call |
| 11 | Crossbar | Receiving an incoming phone call |
| 12 | Active Ribbon | Sending a multi-media message |
| 13 | Active Ribbon | Sending a multi-media message |
| 14 | Active Ribbon | Retrieving a history |
| 15 | General | Reviewing previous activity |
| 16 | General | Using a wizard |
| 17 | General | Displaying most probable items |
| 18 | General | Finding out status of social contacts |
| 19 | General | Performing a search |

### Slider Bar

In accordance with embodiments of the present invention, a slider bar is operated by a one-finger movement. The slider bar supports the following operations:

| | |
|---|---|
| Up/Down | Navigation |
| Press | Select/Open Item |
| | At a last tree level, open Options menu |
| Press Long | Open Options menu |

The slider bar may be touch-based, or a physical slider bar as shown in FIG. 3. For a touch-based slider bar, these operations are performed by a finger on screen 110. For a physical slider base, these operations are performed on by a finger on slider bar 120.

Reference is made to FIG. 4, which is an illustration of a user interface operative for making an outgoing call using a slider bar, in accordance with an embodiment of the present invention. The user interface shown in FIG. 4 is activated via modular communicator 100.

At stage (a), the main menu from FIG. 2, with a list of applications, is displayed. A user slides the slider bar down to scroll to the “Contacts” menu item, and presses to select the scrolled-to item. In response, the user's contact list is displayed at stage (b). The user slides the slider bar down to scroll to a desired entry; namely, “Ohad Elboiem”, and presses long. In response, a vertical list of options is displayed at stage (c). The user presses to select the “Call” option, which is the first and currently-selected option. In response, a screen indicating that an outgoing call is being made to Ohad Elboiem is displayed at stage (d). When the call is connected, the user may touch to activate a speaker as indicated at stage (e). Alternatively, the user may press long to bring up a list of actions that can be performed during the call, as indicated at stage (f).

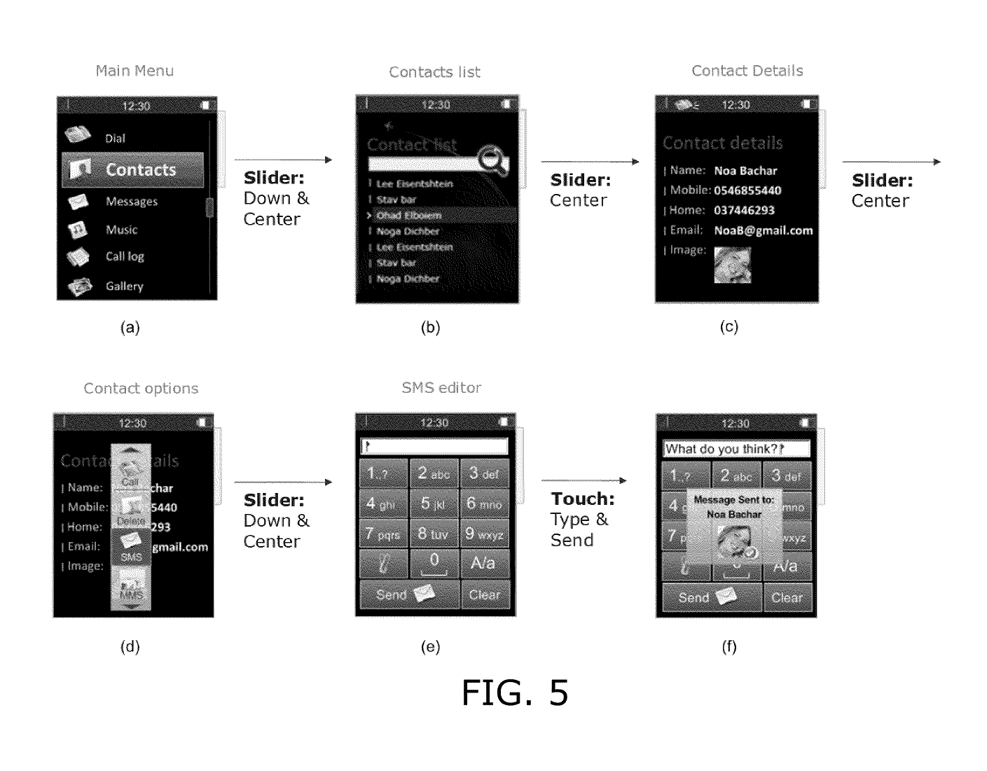

Reference is made to FIG. 5, which is an illustration of a user interface operative for sending a text message using a slider bar, in accordance with an embodiment of the present invention. The user interface shown in FIG. 5 is activated via modular communicator 100.

At stage (a), the main menu with a list of applications is displayed. A user slides the slider bar down to scroll to the “Contacts” menu item, and presses to select the scrolled-to item. In response, the user's contact list, with a list of contact entries, is displayed at stage (b). The user presses again to view the contact details of a selected entry. In response, the details of the selected entry are displayed at stage (c). The user presses again and, in response, a vertical list of options is displayed at stage (d). The user slides down and presses to select the “SMS” option. In response, a screen with an SMS text editor with a touch-based keypad is displayed at stage (e). The user then prepares a text message using the touch-based keypad. When the message is complete, the user touches on a “Send” key to send the text message to the selected contact and, in response, a confirmation is displayed as indicated at stage (f).

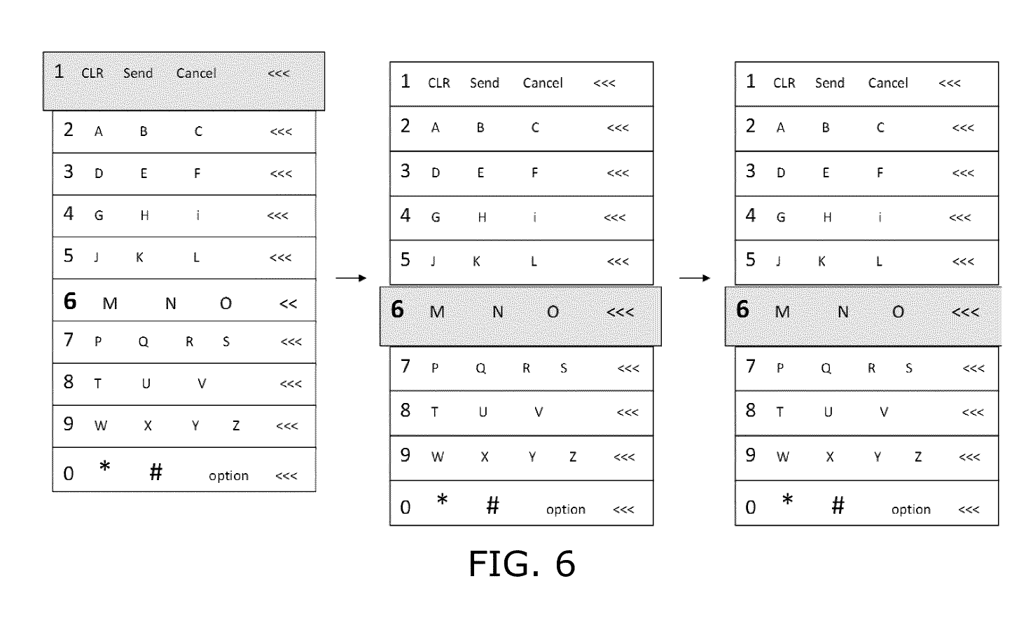

Reference is made to FIG. 6, which is an illustration of a user interface for entering text using a slider bar, in accordance with an embodiment of the present invention. The text editor shown in FIG. 6 includes ten rows of character selections, and is distinct from the keypad shown at stage (e) in FIG. 5. The user interface shown in FIG. 6 is activated via modular communicator 100.

A user slides the slider bar to a desired row of characters, and then presses on the slider bar to toggle through the characters in the scrolled-to row. Thus, as shown in FIG. 6, to input the character “M”, the user slides the slider bar down to the sixth row, and then presses the slider bar to select the “M”.

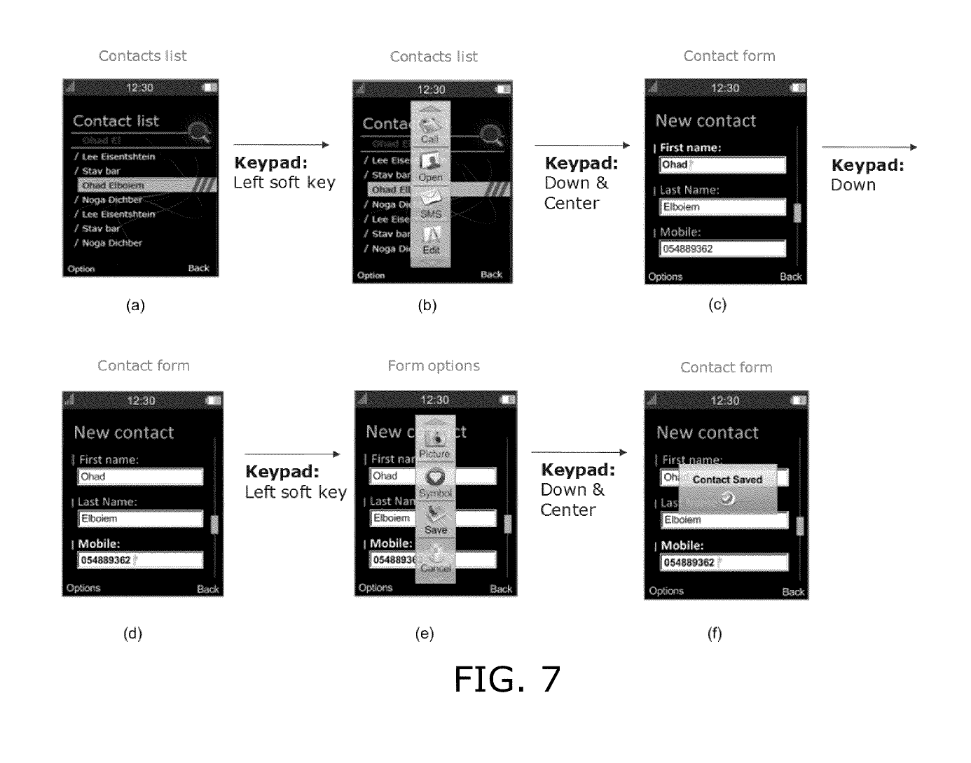

Reference is made to FIG. 7, which is an illustration of a user interface operative for editing an entry in a contact list using a slider bar, in accordance with an embodiment of the present invention. The user interface shown in FIG. 7 is activated via jacket 200. In this embodiment, it is assumed that jacket 200 includes left and right soft keys, a keypad with 12 keys, four navigational arrows around a center key, and a “Clear” key.

At stage (a) the contact list, with a list of contact entries, is displayed. The user presses on a left soft key and, in response, a vertical list of options is displayed at stage (b). The user presses on a down arrow to scroll down to the “Edit” option, and presses on a center key to select the scrolled-to option. In response, a form for editing a contact entry is displayed at stage (c). The user edits the contact entry using the jacket keypad to fill in the form, as indicated at stage (d). When finished editing, the user presses on the left soft key again and, in response, another vertical list of options is displayed at stage (e). The user presses on a down arrow to scroll down to the “Save” option, and presses on the center key to select the scrolled-to option. In response, the contact information is saved, and a confirmation is displayed at stage (f).

### Crossbar

In accordance with embodiments of the present invention, a crossbar is operated by a one-finger movement. The crossbar supports the following operations.

| | |
|---|---|
| Up/Down/Left/Right | Navigation |
| Center | Select/Open Item |

Reference is made to FIG. 8, which is an illustration of a user interface operative for accessing an application using a crossbar, in accordance with an embodiment of the present invention. The user interface shown in FIG. 8 is activated via jacket 200. In this embodiment, it is assumed that jacket 200 includes left and right soft keys, a keypad with 12 keys, four navigational arrows around a center key, a “Clear” key, and a dedicated key referred to herein as a “modu key”.

At stage (a) a crossbar is displayed with four applications indicated at its peripheries. The user touches the key at the center of the crossbar and, in response the main menu with a list of applications is displayed as indicated at stage (b). Alternatively, at stage (a) the user may press the center key in order to bring up the main menu at stage (b). After the main menu is displayed, the user presses on the center key to select the “Contacts” application from the main menu, which is the currently selected application at the top of the list. In response, the user's contact list, with a list of contact entries, is displayed at stage (c). At any stage, the user may press the dedicated modu key and, in response, the crossbar is displayed overlaying the current display, as indicated at stage (d). Similarly, at stage (e), during an ongoing call, pressing the dedicated modu key causes the crossbar to be displayed overlaying the current display, as indicated at stage (f).

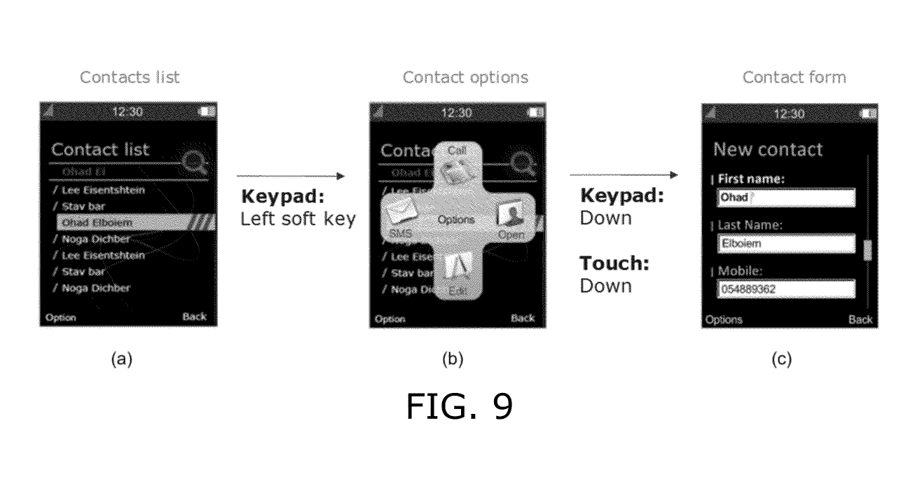

Reference is made to FIG. 9, which is an illustration of a user interface operative for editing an entry in a contact list using a crossbar, in accordance with an embodiment of the present invention. The user interface shown in FIG. 9 is activated via jacket 200. In this embodiment, it is assumed that jacket 200 includes left and right soft keys, a keypad with 12 keys, four navigational arrows around a center key, a “Clear” key, and a dedicated key referred to herein as a “modu key”.

At stage (a) a user's contact list, with a list of contact entries, is displayed. The user presses on the left soft key and, in response, the crossbar is displayed overlaying the contact list at stage (b). The crossbar indicated four applications at its peripheries. The user presses the down navigational key to access the “Edit” application indicated at the bottom of the crossbar. In response, the contact form for editing an entry in the contact list is displayed at stage (c). Alternatively, at stage (b) the user may touch the bottom of the crossbar in order to bring up the contact form at stage (c).

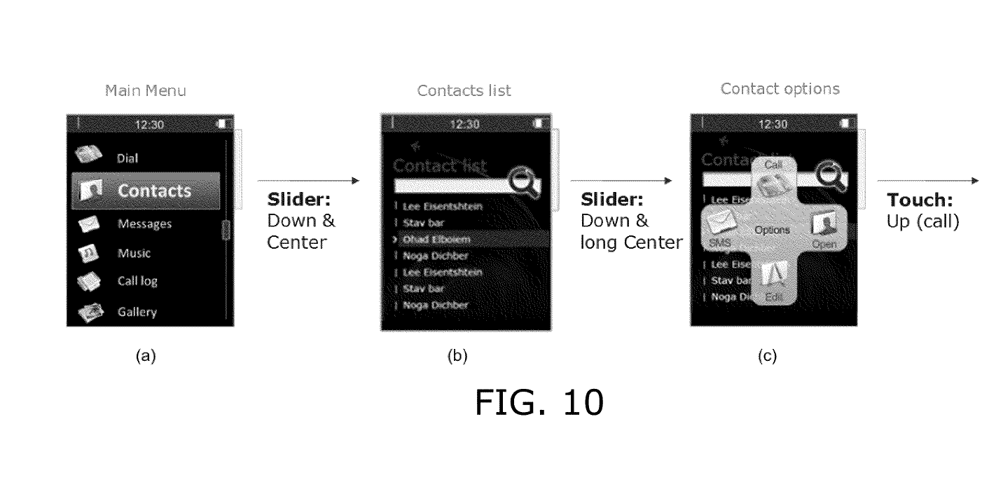

Reference is made to FIG. 10, which is an illustration of a user interface operative for making an outgoing phone call using a crossbar, in accordance with an embodiment of the present invention. The user interface shown in FIG. 10 is activated via modular communicator 100.

At stage (a) the main menu with a list of applications is displayed. The user slides down to scroll to the “contacts” application, and presses to select the scrolled-to application. In response, the user's contact list, with a list of entries, is displayed at stage (b). The user slides down to scroll to the entry for “Ohad Elboiem” and presses long to bring up the crossbar. In response, the crossbar, indicating four actions at its peripheries, is displayed overlaid on the contact list at stage (c). The user then touches the top of the crossbar to make an outgoing phone call to the selected contact.

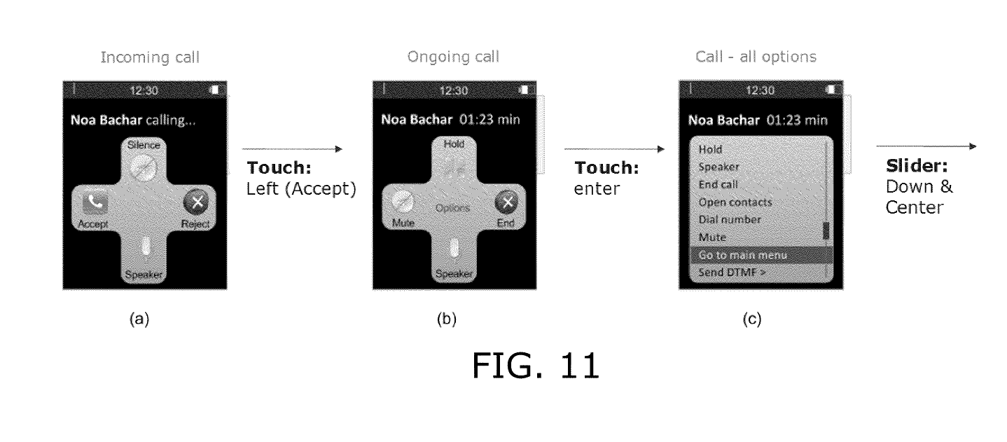

Reference is made to FIG. 11, which is an illustration of a user interface operative for receiving an incoming phone call using a crossbar, in accordance with an embodiment of the present invention. The user interface shown in FIG. 11 is activated via modular communicator 100.

At stage (a) an incoming call is detected and a crossbar with four actions indicated at its peripheries is displayed. The user presses the left of the crossbar to accept the incoming call, and in response the caller is connected to the user. Another crossbar with four actions indicated at its peripheries is displayed, as indicated at stage (b). The user presses the center of the crossbar to bring up a list of options, as indicated at stage (c). The user slides down to scroll to the “Go to main menu” option to bring up the main menu.

### Active Ribbon

In accordance with embodiments of the present invention, an active ribbon is operated by a one-finger movement. The active ribbon is shown at the bottom of the screen in FIGS. 12-14, and includes one or more buttons that can be selected.

Reference is made to FIG. 12, which is an illustration of a first user interface operative for sending a mufti-media message using an active ribbon, in accordance with an embodiment of the present invention. The user interface shown in FIG. 12 is activated via modular communicator 100.

At stage (a) a contact list, with a list of entries, is displayed. An active ribbon is overlaid at the bottom of the display, with buttons for three actions; namely, “Call”, “SMS” and “MMS”. The user touches the “MMS” button and, in response, a mufti-media message form is displayed at stage (b). At this stage, the active ribbon displays a different set of three action buttons; namely, “Send”, “Add Image”, and “Preview”. The user presses a slider to bring up a text editor, as indicated at stage (c). At this stage, the active ribbon displays yet a different set of three action buttons; namely, “Clear”, “Preview” and “Back”. The user completes his text message using the text editor, and touches the “Back” button to bring up the mufti-media message form again, as indicated at stage (d). The user touches the “Send” button to send his message, and a confirmation is displayed is displayed, as indicated at stage (e). Thereafter, the contact list is displayed again, as indicated at stage (f).

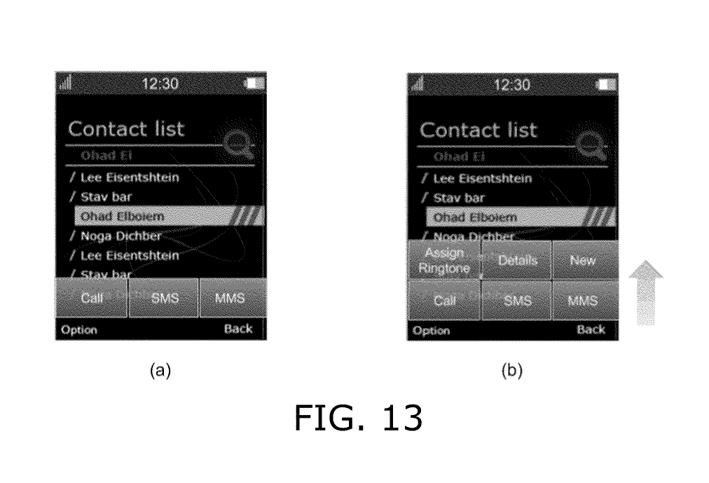

Reference is made to FIG. 13, which is an illustration of a second user interface operative for sending a mufti-media message using an active ribbon, in accordance with an embodiment of the present invention. The user interface shown in FIG. 13 is activated via jacket 200. In this embodiment, it is assumed that jacket 200 includes left and right soft keys, a keypad with 12 keys, four navigational arrows around a center key, a “Clear” key, and a dedicated key referred to herein as a “modu key”.

At stage (a) a user's contact list, with a list of entries, is displayed. At the bottom of the display, an active ribbon shows three buttons; namely, “Call”, “SMS” and “MMS” buttons. The user slides a bar upwards and, in response, the active ribbons expands and addition buttons are displayed as indicated at stage (b); namely, “Assign Ringtone”, “Details” and “New” buttons.

Reference is made to FIG. 14, which is an illustration of a user interface operative for retrieving a history using an active ribbon, in accordance with an embodiment of the present invention. The user interface shown in FIG. 14 is activated via jacket 200. In this embodiment, it is assumed that jacket 200 includes left and right soft keys, a keypad with 12 keys, four navigational arrows around a center key, a “Clear” key, and a dedicated key referred to herein as a “modu key”.

At stage (a) a user's contact list, with a list of entries, is displayed. An active ribbon at the bottom of the display includes three buttons; namely, “Call”, “SMS” and “History” buttons. The user touches the “History” button and, in response, a log showing the history of the user's most recent actions is overlaid on the contact list, as indicated at stage (b).

### General User Interface Features

Reference is made to FIG. 15, which is an illustration of a user interface operative for reviewing previous activity, in accordance with an embodiment of the present invention. The user interface shown in FIG. 15 is activated via modular communicator 100.

A user's contact list, with a list of entries, is displayed at stage (a), with a currently-scrolled to entry, “Ohad Elboiem”, indicated. By pressing on a center key, the user can review his of previous actions in reverse chronological order. As indicated at stage (b), the current display was preceded by a display of a summary of communications with contact Ohad Elboiem. The previous display appears to the left of the current display at stage (b), and appears by itself at stage (c).

Reference is made to FIG. 16, which is an illustration of a user interface operative for providing a wizard, in accordance with an embodiment of the present invention. The user interface shown in FIG. 16 is activated via modular communicator 100.

At stage (a) a user's contact list, with a list of entries, is displayed, with a currently scrolled-to entry, “Ohad Elboiem” indicated. A wizard steps the user through a process of selecting a ringtone, as indicated at stage (b), and assigning the ringtone to Ohad Elboiem, as indicated at stage (c).

Reference is made to FIG. 17, which is an illustration of a user interface operative for displaying most probable items, in accordance with an embodiment of the present invention. The user interface shown in FIG. 17 is activated via modular communicator 100.

Generally, with each activity, the most probable items a user will access are displayed at the top of the display. Thus, with reference to a user's contact list, some number, n, of most probable contact entries that the user will select are displayed at the top of the list, as indicated at stage (a). In FIG. 17, n is set to 3, and the three most probable entries are displayed. Alternatively, n most recent contact entries added to the list may be displayed at the top of the list. The entries displayed at the top of the list are also accessible within the full list by scrolling through the list. Similarly, with reference to a music list with entries for songs from a user's music library, n most probable songs that the user will select are displayed at the top of the list, as indicated at stage (b). Alternatively, n most recent songs added to the user's music library may be displayed at the top of the list. Similarly, with respect to a photo list with entries for images from a user's photo gallery, icons for n most probable images that the user will select are displayed at the top of the list, as indicated at stage (c). Alternatively, icons for n most recent image added to the user's photo gallery may be displayed at the top of the list.

Reference is made to FIG. 18, which is an illustration of a user interface operative for finding out status of social contacts, in accordance with an embodiment of the present invention. The user interface shown in FIG. 18 is activated via modular communicator 100.

At stage (a) a user's contact list is displayed, with indicators showing current status of the contact entries vis a vis social network applications including inter alia ICQ® owned and operated by ICQ, Inc. of Dulles, Va., Instant Messenger® owned and operated by America Online of Dulles, Va., Facebook® owner and operated by The Facebook, Inc. of Palo Alto, Calif., and Skype® owned and operated by Skype Limited Corp. of Dublin, Ireland. The contact list is currently scrolled to an entry “Lori Cohen”. A menu of direct links to the social network applications is indicated at stage (b), and enables a user to directly interact with the scrolled-to contact.

Reference is made to FIG. 19, which is an illustration of a user interface operative for performing a search, in accordance with an embodiment of the present invention. The user interface shown in FIG. 19 is activated via modular communicator 100.

A main menu is displayed at stage (a) with a field for performing a search shown at the bottom. A user may search for all content matching a given text string. Alternatively, the entire screen may be allocated to the search field, as indicated at stage (b). As seen in FIG. 16, the user has entered a search string “Ron”. In response to performing the search, search results are presented as indicated at stage (c), and include inter alia contact entries, songs, images and calendar entries.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A user interface for a mobile electronic device, comprising a slider bar that supports three user inputs; namely, (i) slide up, (ii) slide down, and (iii) press, wherein slide up and slide down cause respective scrolling up and scrolling down through a menu of items, and wherein press causes selection of a scrolled-to menu item.

2. The user interface of claim 1 wherein said slider bar supports multiple levels of slide up and slide down inputs, and wherein the multiple levels cause different rates of scrolling through the menu of items.

3. The user interface of claim 1 wherein said slider bar also supports a long press, and wherein said long press causes a menu to be displayed.

4. The user interface of claim 1 wherein said slider bar comprises a touch-based slider bar responsive to finger movements on a touch-sensitive screen.

5. The user interface of claim 1 wherein said slider bar comprises a physical control responsive to finger movements on the physical control.

6. The user interface of claim 5 wherein said physical control comprises a switch.

7. The user interface of claim 5 wherein said physical control comprises a dial.

8. The user interface of claim 1 wherein the mobile electronic device includes a text message, wherein the menu of items is a list of rows of character sequences, and wherein selection of a scrolled-to row toggles through the character sequences for entry into a text message.

9. The user interface of claim 1 wherein the mobile electronic device includes a cellular phone, wherein the menu of items is a list of entries in a contact list, and wherein selection of a scrolled-to contact entry causes the cellular phone to call the selected contact entry.

10. The user interface of claim 1 wherein the mobile electronic device includes a media player, wherein the menu of items is a list of media content, and wherein selection of a scrolled-to media content causes the media player to play the selected media content.

11. The user interface of claim 1 wherein the mobile electronic device includes an image viewer, wherein the menu of items is a list of images, and wherein selection of a scrolled-to image causes the image viewer to render the selected image.
